(19) United States
(12) Patent Application Publication
(10) Pub. No.: US 2017/0254139 A1
(43) Pub. Date: Sep. 7, 2017

(54) PACKING ELEMENT FOR A PANEL

(71) Applicant: Simon Christopher Braid, Peterborough (GB)

(72) Inventor: Simon Christopher Braid, Peterborough (GB)

(21) Appl. No.: 15/447,894

(22) Filed: Mar. 2, 2017

(30) Foreign Application Priority Data
Mar. 2, 2016 (GB) 1603614.7

(51) Int. Cl. E06B 3/54; E06B 3/66

(52) U.S. Cl. CPC E06B 3/5409; E06B 3/6621

(57) ABSTRACT

A packing element (20) for a panel. The packing element (20) is adapted to be mounted on at least one edge of the panel (102) and arranged to support the panel (102) within a frame (104). The packing element comprises: a base (25); a plurality of engagement members (2) which project from the base (25) to support the panel in the frame (104), wherein the base (25) has a first side that faces outwards from the panel (102) and a second side that faces towards the panel (102); at least some of the engagement members (2) comprise deformable fingers (2), each of said fingers (2) having a proximal end that is fixed to the first side of the base and a free distal end, wherein the fingers (2) are adapted to bend when the panel (102) is inserted into the frame (104).

### CROSS REFERENCE TO RELATED APPLICATIONS

This application claims priority to UK Patent Application No. 1603614.7 filed on Mar. 2, 2016, the entire disclosure of which is hereby incorporated by reference and relied upon.

### BACKGROUND OF THE INVENTION

Field of the Invention

The present invention relates to window assemblies for buildings, and in particular to mounting glazing units within window frames of such window assemblies. More specifically it relates to a packing element for mounting on a glazing unit to support the glazing unit within the window frame; a packing assembly comprising a plurality of packing elements, a glazing assembly including at least one packing element; and a window including the glazing assembly.

Description of Related Art

Windows comprise a glazing unit mounted within a surrounding frame. The glazing unit is typically a sealed double glazing unit comprising two parallel spaced apart panes of glass joined and sealed around their edges to enclose a space between the panes. The frame is made up from a number of sections, joined together at their ends and the corners of the frame. The frame may be made from wood, metal, or more commonly now plastic, for example uPVC. The inside edge of the frame defines a rebate to receive the glazing unit within the frame with the frame surrounding the glazing unit.

The frame and glazing units are manufactured separately, and must be matched so that the glazing unit fits within the frame. However due to manufacturing variability and tolerances, and to enable the glazing unit to be fitted into the frame, there is a varying clearance (typically up to 6 mm) between the glazing unit and frame.

Accordingly in order to securely locate and fix the glazing unit within the frame, spacers or packing elements are fitted between the edges of the glazing units and frame. The spacers and packing elements are arranged take up the clearances between the frame and glazing unit to locate the glazing unit and wedge the glazing unit within the frame. In addition to locating the glazing unit within the frame, this also stiffens the frame and window assembly.

Conventionally such spacers or packing elements comprise pairs of wedges which are located between the glazing unit and frame. Each pair of wedges is arranged with their inclined surfaces overlying each other along the edge of glazing unit and within the plane of the glazing unit and frame. In use the wedges are slid relative to each other laterally parallel to plane of the window and along the edge of the glazing unit such that one wedge and inclined surface rides up over the other increasing the overall height of the overlying wedges and taking up the clearance between the glazing unit and frame. An example of such an arrangement is described in GB 2,251,261 A. GB 2,314,265 A shows (FIG. 3) a similar variable thickness packing arrangement comprising two angled wedges, although this patent is directed to door panels.

While such packing arrangements function adequately, the pairs of wedges are relatively difficult to fit between the glazing unit and frame. In addition it is relatively difficult and awkward to get access to the wedges to slide them laterally along the edge of and between the glazing unit and frame. Furthermore the glazing unit must be held in place within the frame until and whilst the wedges are slid to take up the clearance between glazing unit and frame to secure the glazing unit in place. This makes assembly difficult in particular for a single installer.

Alternative packing and spacing arrangements, and in particular packing elements to be fitted between the glazing unit and frame, are described in EP0716206 and EP0599051. These packing elements comprise a panel having a resilient projecting arcuate bulge oriented transversely to the panel and edge of the glazing unit. The packing element is fitted into the frame and the glazing unit then installed with the edge of the glazing unit riding up over and compressing the arcuate bulge. The clearance, and any variation in clearance, between the glazing unit and frame is taken up by the resilience and deformation of the arcuate bulge. Such packing elements can however only accommodate a limited variation in clearance between the glazing unit and frame and can be improved upon.

Various other glazing packing arrangements are described, for example, in: GB 1,537,289, which describes the use of spacer elements comprising incompressible spacer blocks; GB 1,150,807, which also shows the use of setting blocks to space the glazing unit form the frame; GB 2,344,846, which a glazing packing arrangement which has an extension to secure and space a window bead; EP 1,288,427, which describes an L-shaped spacer block in which an arm of the spacer also holds the frame in the frame; and GB 2,309,248, which also describes an L-shaped bead retaining spacer, but which in this case also shows flexible elements which engage and seal against the surface of the window pane.

It is also know to provide fixing member which engage the glazing unit to secure the glazing unit within the window frame. Such fixing member typically comprise upstanding projecting flanges, typically two spaced apart flanges between which an edge of the glazing unit is fitted with the flanges abutting the surfaces of the glazing unit. These fixing members may extend along the entire edge of the glazing unit and also act a water seal. Examples of such arrangements are described, for example, in U.S. Pat. No. 4,006,569, U.S. Pat. No. 4,640,072, and GB 2,279,687. GB2,212,545 also describes the use of a fixing member, but which this time is L-shaped and includes on one upstanding flange.

A packing assembly is disclosed in WO2007/128964, which includes several pairs of first and second packing elements. The first packing element includes a wedge-shaped portion and fits on to the double glazed unit. The second element is deformable and is mounted on the window frame in a manner such that it engages the first packing element, thereby positioning the double glazed unit with respect to the frame. However this type of packing arrangement can be difficult to use since it is necessary to mount packing components into the frame, as well as the glazing unit. This is cumbersome for a fitter.

It is desirable to provide an improved arrangement for mounting glazing units within window frames which addresses at least one of the above-mentioned problems and/or more generally offers an improvement and/or alternative to existing arrangements.

### BRIEF SUMMARY OF THE INVENTION

According to the present invention there is provided a packing element for a panel, said packing element is adapted to be mounted on at least one edge of the panel and arranged to support the panel within a frame. The packing element comprises: a base; a plurality of engagement members which project from the base to support the panel in the frame. The base has a first side that faces outwards from the panel and a second side that faces towards the panel.

At least some of the engagement members comprise deformable fingers that are adapted to bend, in use. Each of the fingers has a proximal end that is fixed to a first side of the base and a free distal end, wherein the fingers are adapted to bend when the panel is inserted into the frame. This enables the packing elements according to deform to fit into different sized clearances between the panel and the frame. Packing elements of this type also better protect the panel prior to insertion into the frame, since the packing elements provide crumple zones at peripheral portions of the panel.

Packing elements of this type can be used to locate a panel within frame. The packing elements according to the invention provide a simplified packing arrangement since no separate packing elements have to be fitted into the frame.

Advantageously the panel can comprise a composite panel. The composite panel includes a plurality of parts. For example, the composite panel can include a plurality of spaced apart panel layers. Advantageously the panel can comprise a glazing unit, and preferably a multi-paned glazing unit such as a double glazed unit or a triple glazed unit. The frame can comprise a window frame.

The panel can comprise a window unit, which includes a window frame and at least one glazing unit mounted in the window frame. The packing elements can be mounted on to the outer edges of the window frame. The packing elements can locate and/or centre the window in an aperture in a wall. The wall acts as a frame in this arrangement.

Advantageously the packing element can be arranged for mounting over a corner of the panel.

The packing element may include at least some non-deformable engagement elements. These engagement members are substantially rigid. These are particularly useful for supporting the weigh to of the panel.

In preferred embodiments the packing element includes first and second parts. Advantageously each of the first and second parts can include a plurality of engagement members that are arranged, in use, to protrude outwardly from the panel. At least one of the first and second parts can include at least some deformable engagement members. In some embodiments each of the first and second parts includes at least some deformable engagement members. At least one of the first and second parts can include at least some non-deformable engagement members. In some embodiments each of the first and second parts includes at least some non-deformable engagement members. In some embodiments one of the first and second parts includes deformable engagement members and the other of the first and second parts includes non-deformable engagement members.

The second part can be inclined with respect to the first part. For example the second part can be arranged substantially perpendicular to the first part. The first part is mountable on to a first outer edge of the panel such that at least some engagement members protrude outwardly from the first outer edge of the panel. The second part is mountable on to a second outer edge of the panel such that at least some engagement members protrude outwardly from the second outer edge of the panel.

The second part can be pivotally connected to the first part, for example by a hinge, and preferably a live hinge. In this arrangement, the packing element is movable between first and second conditions by pivoting the second part with respect to the first part. In the first condition, the packing element is in a non-inclined, substantially linear, condition and is mountable onto one outer edge of the panel. In the second condition, the packing element is inclined with respect to the first part, and the packing element is mountable on to a corner of the panel. The first part is mountable on to a first outer edge of the panel such that at least some engagement members protrude outwardly from the first outer edge of the panel. The second part is mountable on to a second outer edge of the panel such that at least some engagement members protrude outwardly from the second outer edge of the panel.

The engagement members project from the first side of the base. The first side faces outwardly from the panel. Each engagement member has a proximal end, which is fixed to the base. The second side of the base is arranged to abut against at least one outer edge of the panel, and preferably abut against first and second outer edges of the panel. Each engagement member has a free distal end. The engagement members protrude, in a non-deflected state, substantially perpendicularly outwards from the first side of the base.

Advantageously at least some of the engagement members can be elongate. That is, elongate from the proximal end to the distal end. In preferred embodiments at least some of the engagement members can comprise cylindrical projections.

Advantageously at least of the engagement members can be stubby. That is, stubby from the proximal end to the distal end.

Advantageously at least some of the engagement members can be non-deformable. These engagement members are useful for supporting the weight of the panel.

Advantageously the packing element may include a multiplicity of deformable engagement members.

At least some of the engagement members can be arranged in an array of rows and columns on the base. The first part can include a first array of rows and columns of engagement members. The second part can include a second array of rows and columns of engagement members. The columns extend in the longitudinal direction, along at least part of the length of the base. The rows extend in the transverse direction, across at least a part of the width of the base.

In preferred embodiments at least some of the columns and/or at least some of the rows are inclined with respect to a central longitudinal axis of the base and/or a longitudinal edge of the base, when viewed in plan. This reduces the initial force required to insert the panel into the frame.

In some embodiments the height of at least some of the engagement members from the base varies over the length and/or width of the base. In preferred embodiments the height of the engagement members varies within at least one column, and preferably within each column. Optionally, the height of the engagement members may vary within at least one row, and preferably each row. However, in preferred embodiments the heights of engagement members in any given row is substantially constant.

The array of engagement members can comprise a plurality of subgroups. A plurality of subgroups of engagement members can be located on the first part. A plurality of subgroups of engagement members can be located on the second part.

Preferably each subgroup includes around 40 to 70 engagement members, and preferably around 50 to 60 engagement members. The higher the number of engagement members the better the load is spread, and each engagement member deflects less.

In preferred embodiments the subgroups are distributed in the longitudinal direction of the base. Preferably the subgroups are distributed along substantially the full length of the base. Typically the first part includes between 2 and 8 subgroups, and preferably four subgroups. Typically the second part includes between 2 and 8 subgroups, and preferably four subgroups. Each subgroup itself is preferably arranged in an array.

The engagement member heights in at least one subgroup can increase along at least some of the columns, and preferably each of the columns, from a shortest engagement member to a tallest engagement member. Thus, when viewed side on, the engagement member heights along each column within the subgroup taper from the shortest engagement member to the tallest engagement member. The shortest engagement member in each subgroup column can be positioned closet, in the longitudinal direction, to the hinge. The shortest engagement member in each subgroup column can be positioned furthest, in the longitudinal direction, to the hinge. The tallest engagement member in each subgroup column can be positioned closet, in the longitudinal direction, to the hinge. The tallest engagement member in each subgroup column can be positioned furthest, in the longitudinal direction, to the hinge. Preferably the height of each engagement member along any given row in the subgroup is substantially constant. A plurality of subgroups can be similarly arranged. Preferably each subgroup is similar.

The subgroups can be arranged such that a row of shortest engagement members in a second subgroup is positioned adjacent a row of tallest engagement members in a first subgroup. Repeating this pattern gives the array a saw teeth arrangement, when viewed side on.

At least some of the engagement members can be in the form of ribs. Preferably at least some of the ribs extend transversely across the width of the base. Preferably at least some of the ribs are arranged parallel to one another. Preferably at least some of the ribs are spaced apart in a longitudinal direction of the base.

The packing element can include a first flange projecting outwardly from the base. The first flange projects from the second side of the base, generally towards the panel. The first flange runs along a first longitudinal edge of the base. The first flange protects a first outer surface of the panel, such as a first pane of glass.

The packing element can include a second flange projecting outwardly from the base. The second flange projects from the second side of the base, generally towards the panel. The second flange runs along a second longitudinal edge of the base. The second flange protects a second outer surface of the panel, such as a second pane of glass.

The first and second flanges define a channel into which at least one edge of the panel can be received. The channel receives one edge, when the packing element is in the first condition. The channel receives two edges when the packing element is in the second condition.

The first and second flanges each include a recess located adjacent the hinge. The recesses enables the second part to pivot relative the first part about the hinge.

The first and second flanges separate adjacent panels when panels are stacked together.

The packing element can include a plurality of formations arranged to engage outer surfaces of the panel. The formations allow for variations in thickness of the panel. The formations can be discrete formations. The formations can be spaced longitudinally along the packing element. The formations can be located on peripheral portions on the base, for example close to the longitudinal edges of the base and/or the flanges. The formations can be formed integrally with the flanges.

The packing element can include at least one projection, and preferably a plurality of projections, arranged to engage an inner part of the panel. The projections can be used to help maintain the distance between first and second panel layers, such as panes of glass. Each projection can be arranged to engage an inner surface of the panel, for example an inner surface of a panel layer such as a pane of glass. The projections can protrude into a panel edge. For example, the panel can comprise recesses along its edges, which are arranged to receive the projections. The projections can attach the packing element to the panel.

Each projection is preferably in the form of an elongate member, such as a rib. Each projection protrudes outwardly from the base. The or each projection protrudes outwardly in a direction opposite from the engagement members. Each projection protrudes from the second side of the base. A plurality of projections can be spaced longitudinally along the packing element. Preferably the plurality of projections is arranged in two parallel lines, which extend longitudinally along the base. Preferably each projection is arranged substantially parallel to a central longitudinal axis of the base. Each projection is preferably located on central portion on the base.

In preferred embodiments the or each projection is bonded to the panel to fix the packing element to the panel.

In some embodiments webbing is provided to stiffen the base. The webbing is preferably provided between pairs of ribs. Preferably the webbing extends transversely across at least part of the width of the base. For example, the webbing can extend transversely from one rib in the pair of ribs to the other rib in the pair of ribs. In preferred embodiments a pair of ribs is connected by a pair of webs, for example to provide a substantially rectangular formation. Preferably at least some of the webs have a convex upper surface. Alternatively at least some of the webs can have planar surface.

In preferred embodiments a plurality of apertures is formed through a central region of the base. The apertures are distributed along the base. The apertures are arranged to allow excess settable bonding material to escape. The bonding material is used to seal the panel and/or bond the packing elements to the panel. Preferably each aperture is located in a portion of the base bounded by a pair of ribs and a pair of webs.

In some embodiments the base is arranged to flex. Thus the packing element can be manipulated by the user to resiliently deform the base when attaching the packing element to the panel. This helps the packing element to be mounted on to some types of panel.

The packing element can include a plurality of holes and/or recesses in the base. The holes and/or recesses are arranged to help the base flex when mounting the packing element on to the panel.

The packing element can include a first skirt at a first end of the base. The first skirt depends from the base in the same direction as the engagement members. This helps to protect engagement members located near the first end.

The packing element can include a second skirt at a second end of the base. The second skirt depends from the base in the same direction as the engagement members. This helps to protect engagement members located near the second end.

A leading edge of at least one of the first and second skirts can include a chamfer, or can be rounded. This helps insertion into the frame. The leading edge, is with reference to the direction of insertion of the panel into the frame.

The packing element can comprise a moulded component. The moulded component can include a thermoplastic such as nylon. The hinge can be moulded into the packing element.

According to another aspect of the invention there is provided a packing assembly including a plurality of packing elements according to any configuration described herein.

According to another aspect of the invention there is provided a panel assembly including a panel and at least one packing element according to any configuration described herein mounted on to at least one edge of the panel.

The engagement members protrude substantially perpendicularly from the or each outer edge on which the packaging element is mounted. The engagement members protrude outwardly from the panel within the plane of the panel.

Advantageously the panel can comprise a composite panel. The composite panel includes a plurality of parts. For example, the composite panel can include a plurality of spaced apart panel layers. Advantageously the panel can comprise a glazing unit, and preferably a multi-paned glazing unit such as a double glazed unit or a triple glazed unit. The glazing unit includes first and second panes of glass. The first and second panes of glass are separated by spacer bars. The frame can comprise a window frame.

A settable material, such as a resin or adhesive, can be applied along the outer edges of the panel.

In preferred embodiments at least one packing element is bonded to the panel. Preferably at least one packing element is bonded to the panel by the settable material. For example, the or each packing element is mounted on to the panel before the settable material sets. The or each packing element includes at least one projection, which protrudes into the settable material. The settable material in its set condition bonds the or each packing element to the panel.

For composite panel arrangements including first and second spaced apart layers, such as a glazing unit having first and second panes of glass, the settable material can be used to seal the composite panel around its outer edges. A triple layered panel, such as a triple glazed unit, would include a third layer such as a third pane of glass. The packing elements can be attached to the composite panel when the panel is manufactured and the settable material can both seal the panel around its outer edges and bond the packing elements to the panel.

In preferred embodiments at least one projection, and preferably a plurality of projections, engage a first inner surface of the panel, such as an inner surface of a first panel layer. At least one projection, and preferably a plurality of projections, engage a second inner surface of the panel, such as an inner surface of a second panel layer.

In preferred embodiments a plurality of formations engage a first outer surface of the panel, such as an outer surface of the first panel. A plurality of formations engage a second outer surface of the panel, such as an outer surface of the second panel.

Preferably the panel includes a first corner. A packing element is mounted over the first corner. The first part of the packing element is mounted on to a first outer edge of the panel. The engagement members located on the first part protrude outwardly from the first outer edge. The second part of the packing element is mounted on to a second outer edge of the panel. The engagement members located on the second part protrude outwardly from the second outer edge.

Preferably the panel includes a second corner. A packing element is mounted over the second corner. The first part of the packing element is mounted on to a third outer edge of the panel. The engagement members located on the first part protrude outwardly from the third outer edge. The second part of the packing element is mounted on to a fourth outer edge of the panel. The engagement members located on the second part protrude outwardly from the fourth outer edge.

The panel can include at least one additional corner. A packing element is mounted over the additional corner.

In preferred embodiments, the panel includes four corners. Packing elements are mounted over each corner.

In preferred embodiments, the panel is substantially rectangular, when viewed in plan. At each corner, two adjacent outer edges are arranged at 90 degrees to one another. However, it will be appreciated that the invention is applicable to non-rectangular panels. For example, the panel may include at least one corner wherein adjacent outer edges are inclined at angle of less than 90 degrees with respect to one another. The panel may include at least one corner wherein adjacent outer edges are inclined at angle of greater than 90 degrees with respect to one another. For example, a panel can have a non-rectangular regular polygonal shape, such as triangular, pentagonal, hexagonal, heptagonal, octagonal, etc. The panel can have an irregular shape. Since the packing element includes a hinge, it has significant flexibility regarding the shape of the panel to which it can be applied. Of course, it may be necessary to manufacture bespoke packing elements if the panel has a particularly unusual arrangement.

The panel can include at least one packing element arranged in a non-inclined state and attached to one outer edge of the panel. The packing assembly can include a plurality of packing units in the non-inclined state. Each packing element in the non-inclined state is attached to one outer edge of the panel.

According to another aspect of the invention there is provided an assembly including a frame and a panel assembly according to any configuration described herein.

The panel assembly is fitted into the frame. The frame surrounds the panel assembly. The packing elements engage the frame, thereby supporting the panel within the frame. The engagement members engage inner surfaces of the frame. The packing elements locate and/or centre the panel within the frame.

In preferred embodiments the frame comprises a window frame and the panel comprises a glazing unit.

In some embodiments the frame is defined by an aperture in a wall.

In some embodiments the panel comprises a window unit, which includes a window frame and at least one glazing unit mounted in the window frame. The packing elements are mounted on to outer edges of the window frame. The window unit is mounted into the aperture in the wall. The engagement members engage inner surfaces of the wall to locate and/or centre the panel within the wall.

At least one packing element, and preferably a plurality of packing elements, engages the frame in first and second directions. The second direction is perpendicular to the first direction.

According to another aspect of the invention there is provided a packing element for mounting on to a panel to support the panel within a frame, the packing element comprising: a base having first and second parts, which are connected by a hinge; wherein the second part is pivotable with respect to the first part between first and second orientations, the first orientation is a non-inclined orientation, wherein the packing element is mountable onto one outer edge of the panel, and the second orientation is an inclined orientation wherein the packaging element is adapted to be fitted on to a corner of the panel such that the first part is mounted on a first outer edge of the panel and the second part is mounted on to a second outer edge of the panel.

According to another aspect of the invention there is provided a packing element for mounting on to a panel to support the panel within a frame, the packing element comprising: a base having first and second parts; and a plurality of engagement members to support the panel in the frame, and which project from the first and second parts of the base.

Preferably the packaging element is adapted to be fitted on to a corner of the panel such that the first part is mounted on to a first outer edge of the panel and at least some engagement members protrude outwardly from the first outer edge, and the second part is mounted on to a second outer edge of the panel and at least some engagement members protrude outwardly from the second outer edge.

Preferably the second part is pivotable with respect to the first part between first and second orientations. The first orientation is a non-inclined orientation, wherein the packing element is mountable onto one outer edge of the panel. The second orientation is an inclined orientation wherein the packaging element is adapted to be fitted on to a corner of the panel such that the first part is mounted on to a first outer edge of the panel and at least some engagement members protrude outwardly from the first outer edge, and the second part is mounted on to a second outer edge of the panel and at least some engagement members protrude outwardly from the second outer edge.

According to another aspect of the invention there is provided a packing element for mounting on to a panel to support the panel within a frame, the packing element comprising: a base having at least one projection, and preferably a plurality of projections, formed on a first side of the base which faces towards the panel, wherein the projections project outwards from the base and are arranged to protrude into at least one recess formed in at least one outer edge of the panel.

Preferably the projections are arrange to mount the packing element to the panel.

The packing element can include an arrangement of protrusions that are arranged to engage outer surfaces of the panel, such as major planar surfaces of the panel.

The panel can include a plurality of spaced apart layers and the or each projection is arranged to engage at least one inner surface of the layers.

Advantageously the packing element can include a plurality of engagement members which project outwardly from a second side of the base in a direction away from the panel and are arranged to support the panel in the frame, at least some of the engagement members being adapted to bend, in use.

According to another aspect of the invention there is provided a packing element for mounting on to a panel to support the panel within a frame, the packing element comprising: a base having first and second parts, which are pivotable with respect to one another; and a plurality of engagement members to support the panel in the frame, at least some of said engagement members being mounted on the first part and at least some of said engagement members being mounted on the second part; wherein the second part is pivotable with respect to the first part between first and second orientations, the first orientation is a non-inclined orientation, wherein the packing element is adapted to fit onto one outer edge of the panel, and the second orientation is an inclined orientation wherein the packaging element is adapted to fit on to a corner of the panel such that the first part is mountable on to a first outer edge of the panel and at least some of the engagement members protrude outwardly from the first outer edge, and the second part is mountable on to a second outer edge of the panel and at least some of the engagement members protrude outwardly from the second outer edge of the panel.

### BRIEF DESCRIPTION OF THE SEVERAL VIEWS OF THE DRAWINGS

These and other features and advantages of the present invention will become more readily appreciated when considered in connection with the following detailed description and appended drawings, wherein:

FIG. 1 is an isometric view of a packing element in accordance with a first embodiment of the invention in a first configuration, the first configuration being a flat configuration;

FIG. 2 is an isometric view of the packing element of FIG. 1 in a second configuration, the second configuration being an inclined configuration, and showing surfaces which, in use, face towards the glazing unit;

FIG. 3 is an end view of the packing element of FIG. 1 when mounted on a glazing unit, the glazing unit being shown in cross-section;

FIG. 4 is a cross-sectional view of the packing element of FIG. 1 when mounted on a glazing unit, the glazing unit being shown in cross-section;

FIG. 5 is an isometric view of the packing element of FIG. 1 in the second configuration, and showing more clearly deformable fingers which, in use, are oriented outwardly from the glazing unit;

FIG. 6 is an end view of the packing element of FIG. 5, showing the arrangement of deformable fingers;

FIG. 7 is an isometric view of a window assembly including four packing elements, a glazing unit and a window frame, wherein each packing element is in the second configuration and mounted on a corner of the glazing unit; and illustrates the manner in which the glazing unit and packing elements are inserted into the window frame;

FIG. 8 shows the window assembly of FIG. 7 with the glazing unit and packing elements located within the frame, the packing elements centring the glazing unit within the frame;

FIG. 9 presents detail A from FIG. 8, and shows a packing element mounted over a corner of the glazing unit, and some of the deformable fingers engaging the frame;

FIG. 10 is an isometric view of a packing element in accordance with a second embodiment, said packing element being shown an inclined configuration;

FIG. 11 is an isometric view of a packing element in accordance with a third embodiment, said packing element being shown an inclined configuration.

### DETAILED DESCRIPTION OF THE INVENTION

Referring to the figures, wherein like numerals indicate like or corresponding parts throughout the several views, FIGS. 1 to 6 show a packing element 20 according to a first embodiment of the invention.

A packing system according to the invention includes a plurality of the packing elements 20, and typically at least four packing elements 20. The packing system is used to protect a glazing unit 102 prior to mounting into a window frame 104, for example to protect the corners and/or edges of the glazing unit from damage and to protect the panes of glass from damage when stacking glazing units. The packing elements 20 are also used to locate and centre the glazing unit 102 in the window frame 104, taking up any clearance between them.

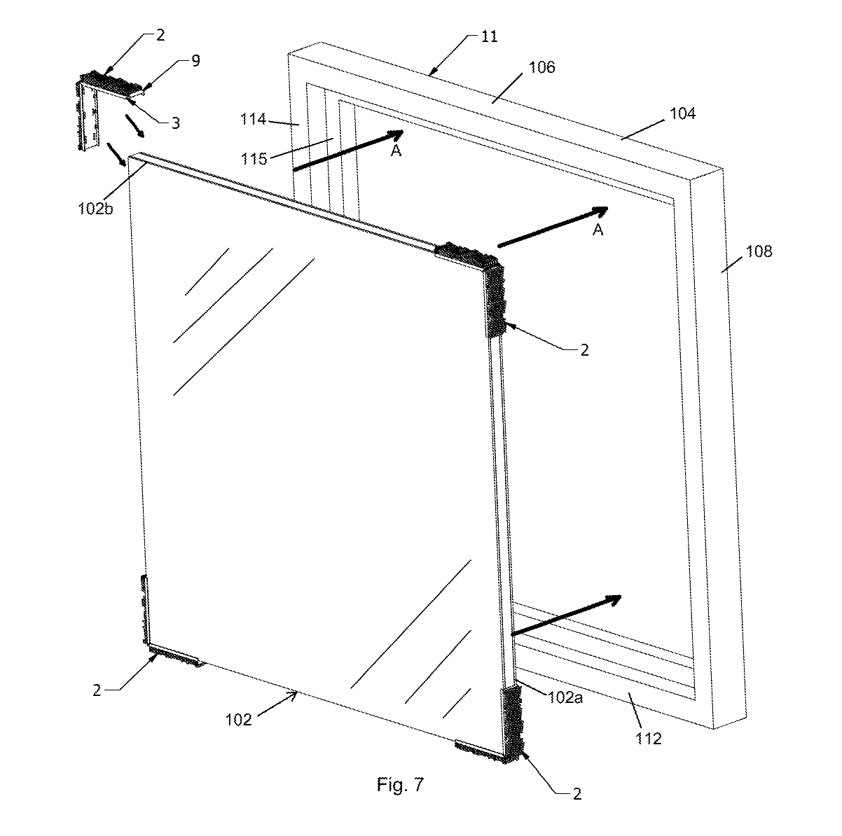

A panel assembly according to the invention is shown in FIG. 7. The panel assembly includes a panel in the form of a glazing unit 102 and a plurality of the packing elements 20.

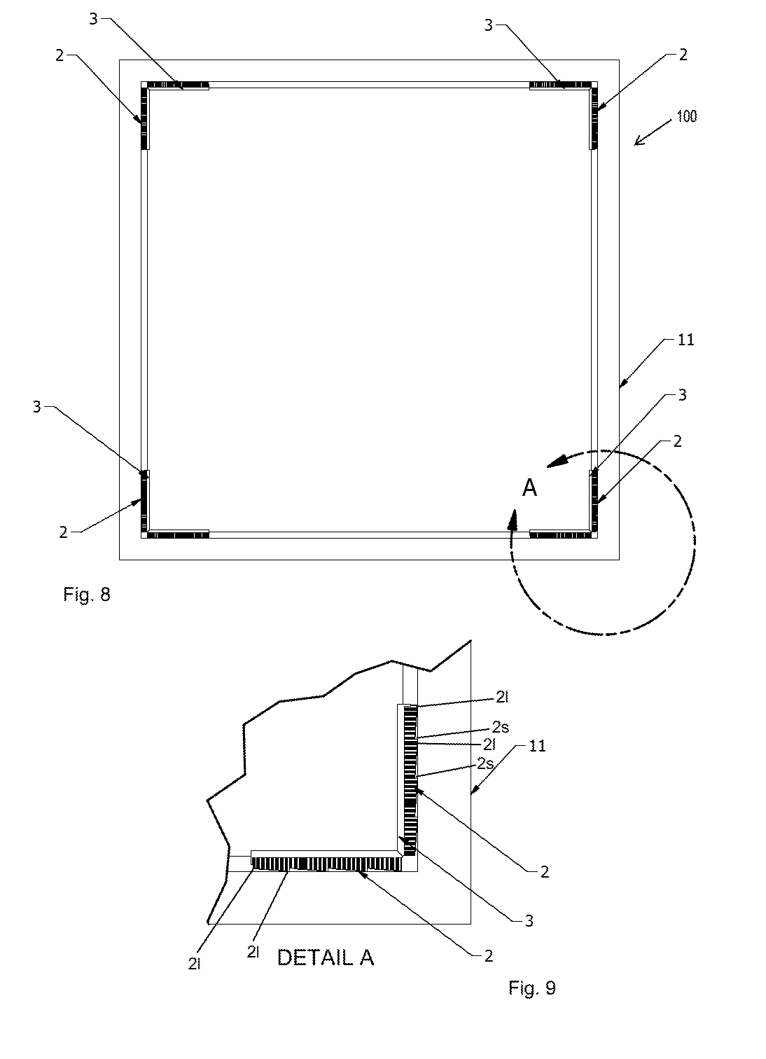

An assembly 100 according to the invention is shown in FIG. 8. The assembly is in the form of a window assembly comprises the glazing unit 102, a window frame 104, and a plurality of packing elements 20 to support and centre the glazing unit 102 within the frame.

The glazing unit 102 is typically a sealed multi-glazed unit, such as a double glazed unit comprising two parallel spaced apart panes of glass 102a, 102b which are joined and sealed around their edges to enclose the space 102c between the panes 102a, 102b. The frame 104 is made up from a number of sections 106,108,112,114 joined together at their ends to form the corners of the frame 104. The frame 104 may be made from wood, metal, or more commonly now plastic, for example uPVC. A rebate is defined along the inside of the frame 104 to receive the glazing unit 102 within the frame 104 with the frame 104 surrounding the glazing unit 102. In particular, as shown, the front of the frame 104 and rebate includes an inwardly extending front flange 115 against which a front face of the front pane 102a of the glazing unit abuts. Once the glazing unit 102 is fitted within the frame a rear bead (not shown) is installed against the rear face and rear pane 102b of the glazing unit 102 such that the glazing unit 102 is located and secured between the front flange 115 and rear bead.

It will be appreciated that reference to ‘front’ and ‘rear’ refer to the installed positions of the window assembly 100, in the particular arrangement shown and may be reversed in other embodiments.

The frame 104 may have other configurations to that shown, and may for example be subdivided to define openings for and rebates to receive further glazing units 102 within the frame. In addition the window assembly 100 and frame 104 may be movably mounted, for example pivotally mounted, within a further outer frame (not shown) to provide an opening window. The outer frame may also include further glazing units 102 and/or window assemblies 100 mounted therein.

Each packing element 20 includes first and second parts 22, 24. The first and second parts 22, 24 are connected together by a hinge 1.

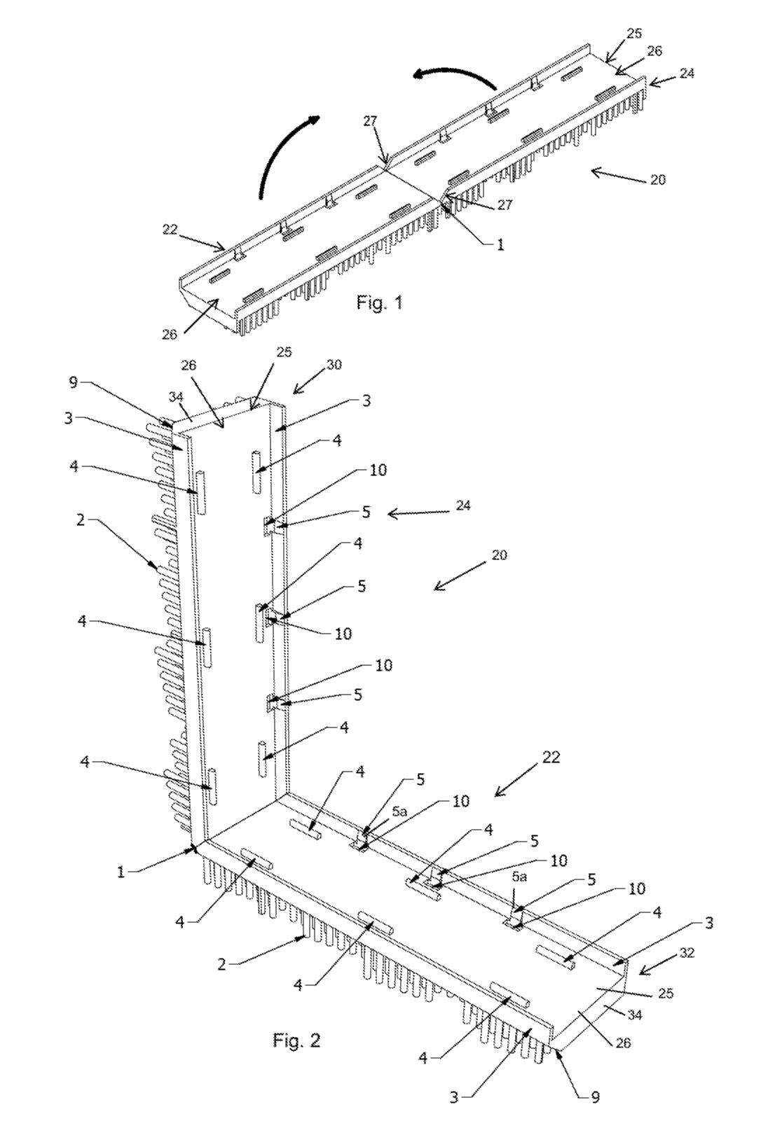

FIG. 1 shows the packing element 20 in a first configuration, which is a flat, non-folded configuration. In this arrangement the packing element 20 is particularly suited for attachment to one edge of the glazing unit 102. The packing element 20 is generally rectangular in the first configuration. FIG. 2 shows the packing element 20 in a second configuration, wherein the second part 24 is inclined with respect to the first part 22. Typically, in the second configuration, the second part 24 is arranged substantially perpendicular to the first part 22. In this arrangement the packing element 20 is substantially L-shaped, and is particularly suited for attachment to first and second edges of the glazing unit 102 at a corner of the glazing unit 102. The packing element 20 can be moved between the first and second configurations by pivoting the second part 24 with respect to the first part 24.

The packing element 20 can be applied at a corner of the glazing unit 102 in the second configuration or to be applied to one edge of the glazing unit 102 in the first configuration. Preferably packing elements 20 are stored in their first configuration.

Typically each packing element 20 comprises a plastics moulded component, which can be made from a thermoplastic, such as nylon. In this arrangement the hinge 1 is preferably a live hinge. The live hinge 1 is formed when moulding the packing element.

Each of the first and second parts 22, 24 has a base 25 which includes a base surface 26. When the packing element 20 is installed along the edge of the glazing unit 102 the base surface 26 is arranged to abut against the edge of the glazing unit 102 and is parallel to the edge of the glazing unit 102 and parallel to the normal of the plane of the glazing unit 102.

Upstanding side flanges 3 project from the base surface 26 and extend along either lateral side of the packing element 20, except in the vicinity of the hinge 1, where a recess 27 is formed in each flange 3, and typically a ‘V’-shaped recess. The recesses 27 enable the first and second parts 22, 24 to pivot relative to one another. The side flanges 3 and base surface 26 define a channel in which the glazing unit 102 fits. The side flanges 3 protect the glazing unit 102. When stacking glazing units 102, the flanges 3 act as spacers between units 102 to prevent pane to pane contact.

Each of the flanges 3 includes formations, such as discrete protrusions 5, which protrude inwardly from an inner surface 3a of the flange. The protrusions 5 are arranged to engage outer surfaces 116a, 116b of their respective panes of glass 102a, 102b. The protrusions 5 are provided to account for slight variations in width for the glazing unit due to manufacturing tolerances. Each protrusion 5 has an upper inclined part 5a, for ease of application to the glazing unit 102. Any practicable number of protrusions 5 can be provided, for example six protrusions are provided on each flange 3 in the figures, three on each of the first and second parts 22, 24. The protrusions 5 are relatively evenly spaced along the flange 3.

Each of the first and second parts 22, 24 includes projections, such as ridges 4, on the base 25, which are arranged to engage inner faces 118a,118b of the panes of glass. The ridges 4 project upwards from the base surface 26. Any practicable number of ridges 4 can be provided, for example six ridges 4 are provided on each part 22, 24 in the figures. The ridges are arranged in a 2 by 3 array along the length of each part of the base 25. It will be appreciated that a different arrangement of ridges 4 may be provided to suit the window type, for example to suit a triple glazed window.

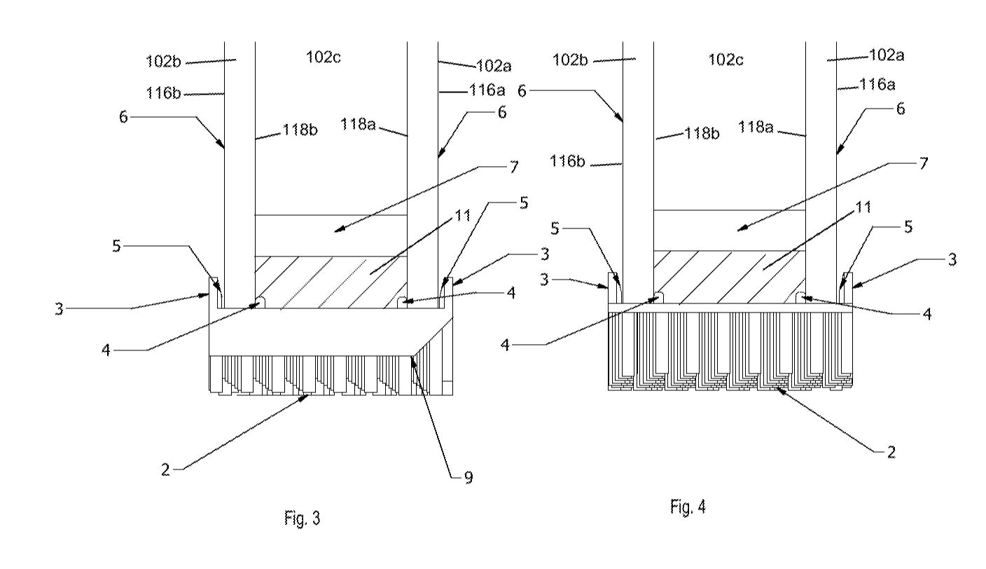

As can be seen in FIGS. 3 and 4, when the packing element 20 is applied to the glazing unit 102, each of the panes of glass 102a, 102b is sandwiched between ridges 4 and protrusions 5. This helps to maintain the structural integrity of the glazing unit, for example it helps to prevent relative movement between the panes of glass 102a, 102b. The glazing unit 102 includes internal glazing bars 7, which are used to space the panes of glass 102a, 102b apart. A resin 11, such as a tar, adhesive, or some other settable material, is applied along the edges of the glazing unit 102, which, when set, seals the glazing unit 102. The packing elements 20 are applied to the glazing unit 102 before the resin 11 is set, which enables the ridges 104 to be inserted into the resin 11 to engage the inner surfaces 118a, 118b of the panes glass. Thus the packing elements 20 are bonded to the glazing unit 102 during the glazing unit 102 manufacturing process.

The packing element 20 includes holes 10, or recesses, formed in the base 25. The holes 10, or recesses, are arranged to assist the packing element to flex, in particular the flanges 3 to flex, when applying the packing element 20 to the glazing unit 102. This additional flexing makes it easier to apply the packing element 20 to the glazing unit 102. The holes 10 are preferably formed adjacent to the protrusions 5, to provide maximum flexibility at the parts of the flange 5, which engage the panes of glass 102a, 102b.

Thus packing element 20 is resiliently deformable to some extent. The packing element 20 as a whole, is sufficiently resiliently deformable to mount on the edges of the glazing unit 102.

Each of the first and second parts 22, 24 includes a plurality of engagement members, in the form of individual deformable fingers 2, which project from the base 25. The fingers 2 project from a side opposite to surface 26, such that when the packing element 20 is mounted on to an edge of the glazing unit 102, the fingers 2 protrude outwardly from that edge.

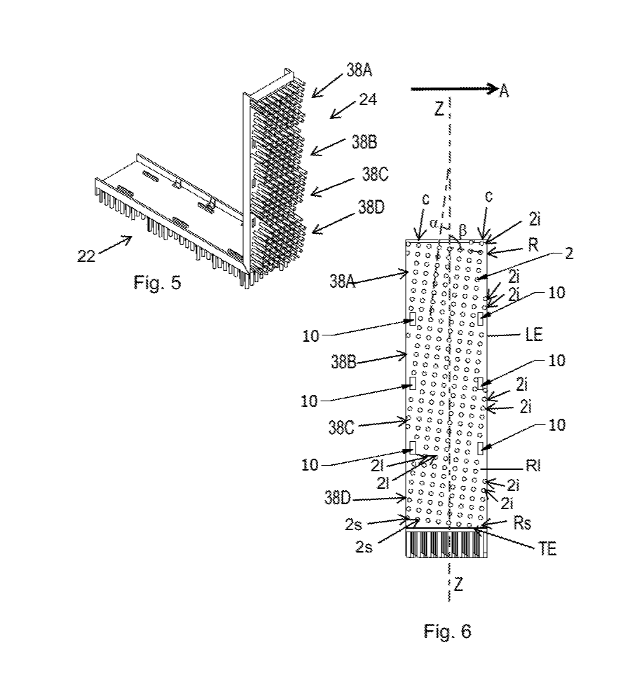

The plurality of deformable fingers 2 are arranged in an array, which can be best seen in FIGS. 5 and 6. The deformable fingers 2 are arranged in rows R across the width of the base, and columns C along the length base 25. However, as will be appreciated from FIG. 6, each of the columns C of deformable fingers 2 is arranged at an angle α with respect to a central axis Z-Z, when viewed in plan. Each of the rows R of deformable fingers 2 is arranged at an angle β with respect to the central axis Z-Z, when viewed in plan. Since the base 25 is substantially rectangular, the columns C and rows R of deformable fingers 2 are inclined to the longitudinal and transverse edges LE, TE of the base 25.

The effect of having columns C of fingers extending somewhat diagonally is to reduce the number of deformable fingers 2i which initially engage the frame 104 as the glazing unit 102 is inserted into the frame 104. If the packing element 20 is inserted into the frame 104 in the direction of arrow A in FIG. 6, it can be seen that only a relatively small number of the deformable fingers 2i distributed adjacent the leading edge of the packing element 20 will initially engage the frame 104. As the glazing unit 102 is inserted further into the frame 104 the number of deformable fingers 2 that engage the frame 104 increases. This reduces the friction between the packing element 20 and the frame 104 when initially inserting the glazing unit 102 into the frame 104, and therefore reduces the initial force required to insert the glazing unit 102 into the frame 104.

The fingers 2 have varying lengths, as shown in FIGS. 4 and 9. This is to account for different clearances between the glazing unit 102 and frame 104.

In a preferred arrangement, the heights of the fingers vary along each column C. The heights of the fingers along each row R is preferably substantially constant, however the heights of the fingers along each row R may vary for some applications. In a particularly preferred arrangement, the array of fingers 2 is arranged in a plurality of sub-groups. For example, the second part 26 can include an array 38 of fingers 2, which includes four sub-groups 38A-38D. The four sub-groups 38A-38D are distributed along the length of the second part 24. The fingers 2 in each sub-group 38A-38D can be arranged such that the heights of the fingers 2 steadily increase along the columns C (longitudinal direction in FIG. 6). As shown in FIG. 9, the shortest fingers 2s in a subgroup 38A-38D are positioned in row Rs, which is the row in the subgroup 38A-38D which is closest, in the longitudinal direction, to the hinge 1. The longest fingers 21 in the subgroup 38A-38D are positioned in row R1, which is the row in the subgroup which is furthest, in the longitudinal direction, from the hinge 1. The fingers 2 in between row Rs and row R1, increase in height gradually moving along the columns C in a direction from row Rs to row R1. The effect of this is to provide a tapered sub-group 38A-38D, as can be seen in FIG. 9.

It can be seen from FIGS. 6 and 9, that the subgroups 38A-38D are distributed along the height of the second part 26 in the manner described above, which provides an arrangement similar to saw teeth when viewed side on (see FIG. 9).

The first part 24 is arranged similarly to the second part 26, except that the tallest fingers 21 in each subgroup 38A-38B are positioned closest, in the longitudinal direction, to the hinge 1. The shortest fingers 2s in a subgroup are positioned furthest, in the longitudinal direction, from the hinge 1.

Of course, it will be apparent to the skilled person that different patterns of fingers 2 can be used, for example to take into account the specific profile of a window frame. For example, it may be desirable to taper the heights of fingers 2 in the width direction, that is, along the rows. It may be desirable for the leading fingers, in the direction of insertion, to have greater or shorter heights with respect to the other fingers. It may be desirable for the trailing fingers, in the insertion direction, to have greater or shorter heights with respect to the other fingers.

In this embodiment each of the deformable fingers 2 comprises a generally cylindrical body. Each cylindrical body is connected to the base at one end, and protrudes substantially perpendicularly outwards from the base 25. The distil end of each cylindrical body is free to deflect when loaded transversely at the distal end.

The packing element 20, and specifically the fingers 2 are made of a flexible resilient material, preferably a thermpolastic, such that the fingers 2 are flexible and can be deformed and deflected. Thus the fingers 2 are sufficiently flexible to bend when loaded. Typically, deformation is mainly elastic deformation, however in some circumstances some plastic deformation may also occur. Specifically the fingers 2 are adapted and arranged to deflect during assembly of the window 100 by the frame 104. Accordingly the fingers 2 can be bent into a deflected state such that the thickness of the packing element 20 matches the clearance between the frame 104 and edge of the glazing unit 102. In this regard it will be appreciated that the thickness of the packing element 20, varies depending upon the deflection and amount of bending of the deformable fingers 2. Once installed the deflection and bending of the fingers 2 then urges the glazing unit 101 away from the frame 104 and generates a force perpendicular to the respective section of the frame 106,108,112,114 in the plane of the window 10, between the glazing unit 102 and the frame 104. It will be appreciated that the packing element 20 and fingers 2 are shown schematically in the figures in their natural undeflected state.

At each end 30,32 of the packing element 20, there is provided a skirt 34, which depends from the base 25. The skirt 34 is arranged to provide some protection to the fingers 2, and to stiffen the base 25. The leading edges 9 of the skirts are chamfered for ease insertion into the window frame 104.

An assembly process for a window 100 will now be described with reference to FIGS. 7 to 9.

The packing elements 20 are normally stored in their first configuration, as shown in FIG. 1.

When manufacturing the glazing unit 102, the resin 11 is applied adjacent the edges of the glazing unit 102 in order to seal the unit. Before the resin 11 is set, the packing elements 20 are mounted on to the glazing unit 102. One packing element 20 is applied to each corner of the glazing unit, as shown in FIG. 7, such that the base surface 26 faces towards the glazing unit edge and the fingers 2 protrude outwardly from the edge of the glazing unit 102. The packing elements 20 are mounted such that one of the first and second parts 22, 24 is mounted on to a one edge and the other of the first and second parts 22, 24 is mounted to a different edge.

Each packing element is mounted 20 on the glazing unit such that each pane of glass 102a, 102b is seated between the protrusions 5 and the ridges 4. The ridges 4 abutting against the inner surfaces 116a, 116b of the panes. The protrusions 5 abutting against the outer surfaces 118a, 118b of the panes. The chamfers 38 face in the direction of insertion into the frame 104.

The ridges 4 project into the resin 11. When the resin 11 sets, the packing elements 20 are firmly bonded to the glazing unit 102, to form a glazing assembly. The fingers 2 in their undeflected state, are generally parallel to the plane of the window 100.

At this stage the glazing unit 102, may be mounted into the frame 104, or it may be stored for later use. If stored, several glazing units 102 can be stacked together. The flanges 3 of the packing elements 20 separate the glazing units 102 in the stacked condition. The flanges 3 prevent glass to glass contact and therefore reduce the amount of damage that occurs to the glazing units 102.

Furthermore, the presence of the packing elements 20 makes the glazing unit 102 much more robust. The packing elements 20 help to prevent the panes of glass 102a, 102b from moving relative to one another, and can prevent damage to glazing units, particularly at the corners which are the weakest parts of a glazing unit. For example, the packing elements 20 can protect the glazing units 102 from minor impacts, for example if dropped on to a corner.

To assemble the window 100, the glazing assembly is mounted into the frame 104 in the manner shown in FIG. 7.

The glazing assembly is inserted into the window frame 104 in a direction perpendicular to the plane of the frame 104, as indicated by arrows A in FIG. 7. The glazing unit 102 is pushed forwards until flanges 3 abut against the front flange 115 of the frame. As the glazing unit 102 is inserted the deformable fingers 2 are pressed against the frame 104. This deflects the fingers 2 to reduce the thickness of the packing element 20 and allows the glazing unit 102 to be fitted into the frame 104 with the packing elements 20 between the glazing unit 102 and frame 104. In other words the deformable fingers 2 are squashed, reducing the thickness of the packing element 20 thereby allowing the glazing unit 102 to be fitted into the frame 104.

It will be appreciated that the inclined arrangement of the array of fingers 2 assists in deflecting the fingers 2 and allows easier insertion of the glazing unit 102 into the frame, since fewer fingers initially engage the frame upon insertion. Also, as can be seen in FIG. 9, due to the varying lengths of the fingers 2, not all of the fingers 2 necessarily engage the frame. The number of fingers 2 that engage the frame 104 depend on the heights of the fingers and the clearance between the frame 104 and glazing unit 102.

The packing elements 20 are arranged to fill the clearance between the glazing unit 102 and frame 104. The packing elements 20 take up the clearance, and any manufacturing variations in the clearance between the glazing unit 102 and frame 104 and locate the glazing unit 102 within the frame 104. In addition the packing elements 20 apply a load (in the plane of the window 100 and glazing unit 102) between the glazing unit 102 and frame 104 to frictionally secure the glazing unit 102 within the frame 104. This loading, and the secure location and fixing of the glazing unit 102 within the frame 104, also stiffens the frame 104 and whole window assembly 100. The packing elements 20 mounted along the top and bottom edges of the window assembly 10 apply and generate a vertical acting force, and the packing elements 20 mounted on the sides of the window assembly 10 generate and apply a lateral horizontal loading and force. As a result, and by mounting the packing elements 20 around the frame 104, the packing elements 20 load and centre the glazing unit 102 within the frame 104.

As shown the packing elements 20 are preferably located at the corners of the glazing unit 102 and frame 104. Packing elements 20 located at the corners act together to generate a diagonal loading on and between the glazing unit 102 and frame 104 extending across and in the plane of the glazing unit 102 and frame 104. This urges the diagonally opposite corner of the glazing unit 102 into the diagonally opposite corner of the frame 104. Such diagonal loading of the frame 104 is particularly desirable since it braces and stiffens the window assembly 100 as a whole reducing twisting and flexing of the window frame 104 and window 100. This is particularly important for opening windows in which the frame 104 is movably mounted within a further frame (not shown) and in which the frame 104 is subject to asymmetric loading due to the movable (pivotable) mounting of the frame 104 about one side or edge which can result in twisting and distortion of the frame 104. In such a case, with the window 100 pivotally mounted by a hinge on one side, the packing elements are in particular arranged to apply a diagonal loading from the bottom lower end of the hinge side of the window 100 towards the opposite upper corner of the window 10 to lift the glazing unit 102 within the frame 104 and keep the frame 104 square when opened and supported along the hinge side alone. Such diagonal loading is known in the art as ‘toe and healing’.

As a result as the glazing unit 102 is inserted into the frame 104 it is automatically located and at least temporarily fixed in position within the frame 104 by the packing elements 20, with the deformable element 18 accommodating any variation in clearance between the frame 104 and glazing unit 102. While the embodiments show and relate to a typical square or rectangular window 100 and frame 104, it will be appreciated that the invention is also applicable to other shapes of windows 100.

An advantage of the invention, is that should water enter into the frame, for example if a window seal were to fail, the packing elements would hold the glazing unit out of any pooled water thereby protecting the glazing unit from water damage.

While locating packing elements 20 at the corners is preferred, packing elements 20 can be located elsewhere along the glazing unit 102 instead of, or in addition to the packing elements 20 located at the corners. In particular for large windows 100 further packing elements 20 may be required along the edge of the glazing unit 102 to provide additional packing and support of the glazing unit 102 within the frame 104. The packing elements 20 can be applied to straight edges of the glazing unit 102 in the first, non-inclined, configuration. Packing elements 20 can be applied substantially around the full perimeter of a panel, such as the glazing unit 102. This is especially useful where there is a substantial gap, say around 6 mm clearance between the glazing unit 102 and the frame 104, to help avoid the window being prized open (jemmied open) near a locking point. Having a hinged arrangement enables the packing element to be applied to a rectilinear edge of the glazing unit 102 in the first configuration and to a corner of the glazing unit in the second configuration.

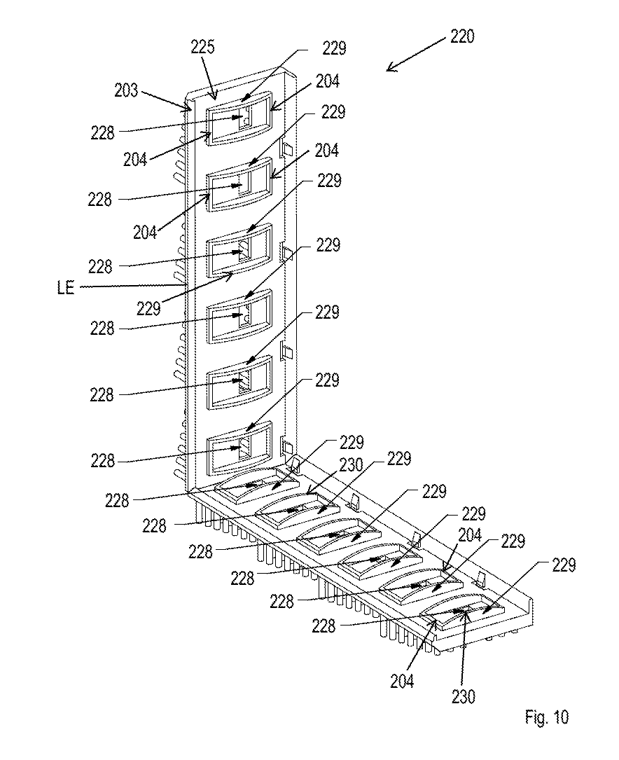

A packing element 220 according to a second embodiment of the invention is shown in FIG. 10.

The packing element 220 is similar to the packing element 20 in the first embodiment except in the following respects.

The number of pairs of ribs 204 distributed over the base 225 is increased from 6 to 12. Each pair of ribs 204 includes a first rib 204a has an associated pair of webs 229. One of the webs 229 extends transversely from a first end of one of the ribs in the pair of ribs to a first end of the other rib in the pair of ribs. The other web 229 in the pair of webs extends transversely from a second end of one of the ribs in the pair of ribs to a second end of the other rib in the pair of ribs. Thus, the ribs 204 and webs 229 define a substantially rectangular shape.

The purpose of the webs 229 is to stiffen the base 225 to help prevent the base 225 from buckling when load is applied to the fingers 202, and to transfer the load closer to the glass edge, which is better able to resist the loading.

Each web 229 has a convex upper surface 230.

Holes 228 are formed through the base 225 to allow excess bonding material, such as a resin or adhesive, which is used to seal the glazing unit 102 and bond the packing element 220 to the glazing unit, to escape. Preferably each hole 228 is located in a portion of the base bounded by a pair or ribs 204 and a pair of webs 229.

The flange 203 on the leading edge LE, is recessed back from the leading edge LE, and is lower in height than the opposite flange. Each flange 203 has a rounded upper edge.

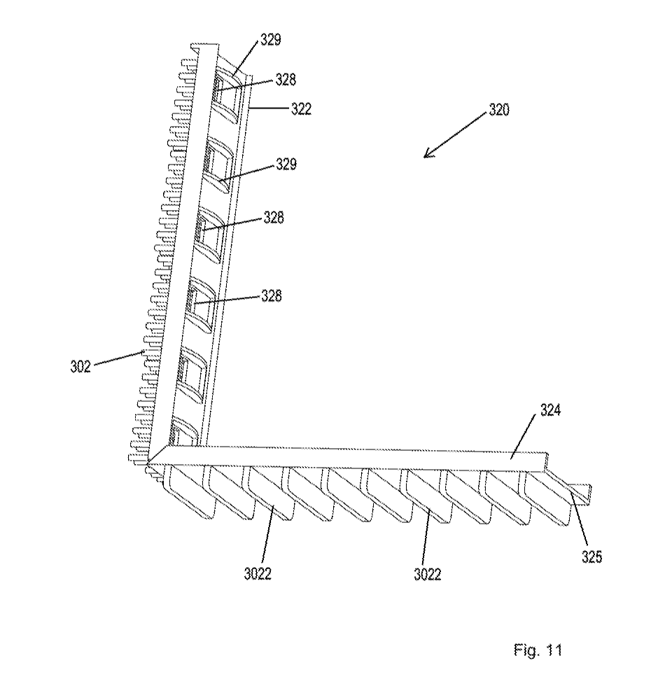

A packing element 320 according to a second embodiment of the invention is shown in FIG. 11.

The packing element 320 is similar to the packing element 20 in the first embodiment except in the following respects.

While the packing element 320 includes elongate fingers 302 similar to those of the first and second embodiments on one 322 of the first and second parts, it includes an arrangement of fingers 3022 of a different type on the other 324 of the first and second parts.

Each finger 3022 is in the form of a rib that extends transversely across width of the packing element. Each finger is stubby, rather than elongate. Several fingers 3022 are included (ten are shown in FIG. 11). The fingers 3022 are arranged substantially parallel to one another. The fingers 3022 are spaced apart along the length of the base. The fingers 3022 are arranged substantially perpendicular to the base 325. The fingers 3022 are arranged to protrude outwards from the glazing unit, when the packing element 320 is mounted there on.

The fingers 3022 can be arranged to deform in use, for example when inserted into the frame or when providing a crumple zone for the panel. For example, in a similar manner to fingers 20.

Alternatively, the fingers 3022 can be arranged such that they do not deform when inserted into the frame. The non-deformable fingers 3022 are substantially rigid. The non-deformable fingers 3022 can be used to provide additional strength to support the weight of the panel, for example when the panel is free standing, and when mounted in the frame. A preferred panel assembly according to the invention may include a panel, such as a glazing unit; a plurality of packing elements 320 according to the third embodiment; and a plurality of packing elements 20, 220 according to at least one of the first and second embodiments. With this arrangement the packing elements 320 can be mounted on to the weight bearing corners and/or edges, typically the lower corners and/or edges, such that the non-deformable fingers 3022 protrude downwards to support the weight of the panel. The panel and the packing elements 20/220 may be mounted on the upper corners to locate and centre the panel in the frame.

With this arrangement the lower portion of the panel assembly is inserted into the frame initially, such that the fingers 3022 support the weight of the panel assembly. At this stage, the panel is typically inclined such that upper part of the panel is out of the plane of the frame. The panel assembly is then pivoted about its lower edge to move the upper part of the panel assembly into the frame. The packing elements 20/220 located on the upper corners and/or upper edges engage an upper part of the frame as the panel is pivoted into the frame.

It will be appreciated that packing element 320 can be arranged to include some deformable fingers 3022 and some non-deformable fingers 3022.

The packing element 320 preferably also includes webbing 329 and holes 328 similar to that described in the second embodiment.

Although the present invention has been described in connection with specific preferred embodiments, it should be understood that the invention as claimed should not be unduly limited to such specific embodiments. Furthermore, it will be apparent to the skilled person that modifications can be made to the above embodiment that fall within the scope of the invention.

For example, the deformable fingers 2 may have other configurations. For example the deformable fingers may have different shapes from cylindrical bodies, such as substantially rectangular bodies.

The packing elements 20 can be made from different materials, such as different thermoplastics.

As an alternative to arranging the packing element 20 in its second condition and then applying it to the glazing assembly, the packing elements 20 may be applied to the glazing unit by attaching one of the first and second parts 22, 24 to a first edge adjacent a corner. The packing element 20 is flexed slightly to fit it on to the first edge. The other of the first and second parts 24,26 is then pivoted about hinge 1 to engage a second edge adjacent the corner.

The hinge can be omitted from the packing element, and each packing element can have a fixed geometry. In this case, the packing system can include at least one first packing element, which substantially corresponds to the packing element in the first configuration, and/or at least one second packing element which corresponds to the packing element in the second configuration.

While the embodiments above have been described with reference to a panel in the form of a glazing unit and window frame, it will be appreciated that the packing elements can be mounted on other types of panels. The panel can be, for example a single pane of glass, or a non-glazing unit such as a wooden panel, plastics panel, and/or metallic panel. For example, packing elements can be attached to a canvas, which is to be mounted into a picture frame. The panel can comprise a single layer, or can comprise a plurality of spaced apart layers. The panel can comprise a single component or the panel can comprise a plurality of component parts.

Packing elements can be used to locate and/or centre the panel within an aperture. For example, the panel can comprise a window unit, comprising a window frame and at least one glazing unit. Packing elements are mounted on to outer edges of the window frame. The window unit and packing elements are mounted into an aperture formed in a wall. In this situation, the frame is defined by inner surfaces of the wall. The packing elements can be used to protect the panel, for example to provide a crumple zone at the corners and/or edges of the panel. The packing elements can be used to separate panels when stacking panels. The invention is particularly suited to protecting panels that are prone to cracking, scratching and/or chipping by rough handling. For this aspect of the invention, it is irrelevant whether or not the panel is finally mounted in a frame or aperture.

While many panels are substantially rectangular, it will be appreciated that the packing elements can be applied to non-rectangular panels.

Each finger 3022 can be arranged to extend longitudinally along at least part of the packing element.

The foregoing invention has been described in accordance with the relevant legal standards, thus the description is exemplary rather than limiting in nature. Variations and modifications to the disclosed embodiment may become apparent to those skilled in the art and fall within the scope of the invention.

What is claimed is:

1. A packing element for mounting on to a panel to support the panel within a frame, the packing element comprising:
a base having first and second parts, which are pivotable with respect to one another; and
a plurality of engagement members to support the panel in the frame, at least some of said engagement members being mounted on the first part and at least some of said engagement members being mounted on the second part;
wherein the second part is pivotable with respect to the first part between first and second orientations, the first orientation is a non-inclined orientation, wherein the packing element is adapted to fit onto one outer edge of the panel, and the second orientation is an inclined orientation wherein the packaging element is adapted to fit on to a corner of the panel such that the first part is mountable on to a first outer edge of the panel and at least some of the engagement members protrude outwardly from the first outer edge, and the second part is mountable on to a second outer edge of the panel and at least some of the engagement members protrude outwardly from the second outer edge of the panel.

2. The packing element according to claim 1, wherein the first part is connected to the second part via a hinge, and preferably a live hinge.

3. The packing element according to claim 1, wherein at least some of the engagement members are deformable and are adapted to bend when the panel is inserted into a frame.

4. The packing element according to claim 1, wherein the base has a first side that faces outwards from the panel and a second side that faces towards the panel; at least some of the engagement members each comprise a finger having a proximal end, which is fixed to the first side of the base and a free distal end.

5. The packing element according to claim 4, wherein in a non-deflected state, the engagement members protrude substantially perpendicularly outwards from the first side of the base.

6. The packing element according to claim 4, wherein at least some of the engagement members comprise cylindrical projections.

7. The packing element according to claim 1, wherein the height of at least some of the engagement members, which is the distance the engagement members extend outwards from the base, varies over the length and/or width of the base.

8. The packing element according to claim 1, wherein the engagement members are arranged in an array of rows and columns on the base, wherein the columns extend generally in the longitudinal direction along at least part of the length of the base, and the rows extend generally in the transverse direction across at least a part of the width of the base.

9. The packing element according to claim 8, wherein at least some of the columns and/or at least some of the rows are inclined with respect to a central longitudinal axis of the base, when viewed in plan.

10. The packing element according to claim 8, wherein the array of engagement members comprises a plurality of subgroups, and the engagement member heights within at least one of the subgroups increase along at least some of the columns from a shortest engagement member to a tallest engagement member.

11. The packing element according to claim 10, wherein the subgroups are arranged on the base such that a row of shortest engagement members in a second subgroup is positioned adjacent a row of tallest engagement members in a first subgroup.

12. The packing element according to claim 4, including at least some non-deformable engagement members, which protrude outwardly from the first side of the base.

13. The packing element according to claim 1, including first and second flanges projecting outwards from the base in the general direction of the panel, wherein the first and second flanges each include a recess located adjacent the pivotable connection.

14. The packing element according to claim 1, including a plurality of formations arranged to engage outer surfaces of the panel.

15. The packing element according to claim 1, including at least one projection arranged to protrude into an edge of the panel.

16. The packing element according to claim 15, wherein panel includes a plurality of spaced apart layers and the or each projection is arranged to engage at least one inner surface of the spaced apart layers.

17. The packing element according to claim 1, wherein the base is arranged to flex, and the base includes a plurality of formations such as holes and/or recesses in the base to facilitate flexing.

18. The packing element according to claim 1, including a first skirt at a first end of the base, the first skirt depending from the base in the same general direction as the engagement members, a second skirt at a second end of the base, the second skirt depending from the base in the same direction as the engagement members; wherein a leading edge of at least one of the first and second skirts includes a chamfer.

19. An assembly including a panel and a plurality of packing element according claim 1 mounted on to at least one outer edge of the panel to form a panel assembly.

20. The assembly according to claim 19, including a frame, wherein the panel assembly is fitted into the frame such that the frame surrounds the panel assembly, and the packing elements engage the frame, thereby supporting the panel within the frame.

21. A packing element for a panel, said packing element being adapted to be mounted on at least one edge of the panel and arranged to support the panel within a frame, the packing element comprising:
a base;
a plurality of engagement members which project from the base to support the panel in the frame, wherein the base has a first side that faces outwards from the panel and a second side that faces towards the panel;
at least some of the engagement members comprise deformable fingers, each of said fingers having a proximal end that is fixed to the first side of the base and a free distal end, wherein the fingers are adapted to bend when the panel is inserted into the frame.

22. A packing element according to claim 21, wherein the base includes first and second parts and is arranged to be mounted on to a corner of the panel, the second part is inclined with respect to the first part, the first part is mountable on to a first outer edge of the panel such that at least some engagement members protrude outwardly from the first outer edge of the panel, and the second part is mountable on to a second outer edge of the panel such that at least some engagement members protrude outwardly from the second outer edge of the panel.

23. A packing element according to claim 21, wherein the base includes first and second parts, the second part is pivotable with respect to the first part between first and second orientations, the first orientation is a non-inclined orientation, wherein the packing element is adapted to fit onto one outer edge of the panel, and the second orientation is an inclined orientation wherein the packaging element is adapted to fit on to a corner of the panel such that the first part is mountable on to a first outer edge of the panel and at least some of the engagement members protrude outwardly from the first outer edge, and the second part is mountable on to a second outer edge of the panel and at least some of the engagement members protrude outwardly from the second outer edge of the panel.

24. A packing element according to claim 21, wherein the engagement members are arranged in an array of rows and columns on the base, wherein the columns extend generally in the longitudinal direction along at least part of the length of the base, and the rows extend generally in the transverse direction across at least a part of the width of the base; wherein at least some of the columns and/or at least some of the rows are inclined with respect to a central longitudinal axis of the base, when viewed in plan.

25. A packing element according to claim 21, wherein the engagement members are arranged in an array of rows and columns on the base, wherein the columns extend generally in the longitudinal direction along at least part of the length of the base, and the rows extend generally in the transverse direction across at least a part of the width of the base, and the array of engagement members comprises a plurality of subgroups, and the engagement member heights within at least one of the subgroups increase along at least some of the columns from a shortest engagement member to a tallest engagement member.
